(19) United States
(12) Patent Application Publication
(10) Pub. No.: US 2010/0255813 A1
(43) Pub. Date: Oct. 7, 2010

(54) SECURITY IN A TELECOMMUNICATIONS NETWORK

(76) Inventors: Caroline Belrose, Wiltshire (GB); Nicholas Bone, Berkshire (GB)

Correspondence Address: STITES & HARBISON PLLC, 1199 NORTH FAIRFAX STREET, SUITE 900, ALEXANDRIA, VA, 22314, US

(21) Appl. No.: 12/667,791

(22) PCT Filed: Jul. 7, 2008
(86) PCT No.: PCT/GB2008/050541

§ 371 Date: Jun. 18, 2010

(30) Foreign Application Priority Data
Jul. 5, 2007 (GB) 0713013.1

(51) Int. Cl. H04W 12/00

(52) U.S. Cl. 455/411

(57) ABSTRACT

A method of controlling a telecommunications terminal (1, 11, 13) requiring an authorised input to perform at least one operation, and including a locking function that locks said at least one operation of the telecommunications terminal. The method comprises selectively transmitting to the telecommunications terminal an unlocking application, receiving the unlocking application at the telecommunications terminal and running the unlocking application to enable said at least one locked operation. The operation may be the full use of the terminal with a selected subscriber identity module. In addition, and preferably in combination, a method and system for a telecommunications terminal to securely receive a message in which the telecommunications terminal has a first environment for running an operating system, and a second environment adapted to be substantially secure against third party tampering. The telecommunications terminal is adapted to receive a message and locate a least part of said message in said second environment.

The present invention relates to a method of and system for controlling a telecommunications terminal. The present invention also relates to a method and system for a telecommunications terminal to securely receive and locate a message.

Mobile or cellular telecommunications terminals, such as those operating in accordance with the GSM or UMTS Standards, operate in association with a SIM provided by the telecommunications network with which the telecommunications terminal has a subscription. Typically, this functional association is provided by inserting the SIM in an appropriate SIM reader in the telecommunications terminal. As is well known, and as will briefly be described below, the SIM includes data that allows the telecommunications terminal to authenticate itself with the network and to receive telecommunications services from the network.

Telecommunications terminals are often configured prior to shipping to an end user to operate fully only when a particular type of SIM is functionally associated with the telecommunications terminal. This procedure is referred to as “SIM locking”. For example, the telecommunications terminal may be configured to only operate fully with particular (authorised) SIMs—for example, SIMs issued by or under control of telecommunications networks providing services in only a particular country or countries; SIMs provided by or under control of a particular network (such as Vodafone®); or only one particular SIM. Any other SIMs are considered to be unauthorised for use with the telecommunications terminal.

A telecommunications terminal may be configured to provide some services when no SIM is functionally associated with it or when an unauthorised SIM is associated with it. For example, the telecommunications terminal may allow emergency calls to be made to the police, ambulance or fire service using a known emergency telephone number.

If an unauthorised SIM is inserted in a SIM locked telecommunications terminal, typically the telecommunications terminal is configured to display a message, requesting that the user enters a SIM unlock code, or may simply display a message indicating that the telecommunications terminal is locked, or a prompt to insert a correct, i.e. authorised, SIM.

In some countries, such as the United Kingdom, it is a requirement for a network provider to allow a telecommunications terminal to have the SIM locking restriction removed in certain circumstances. In order to meet this requirement, telecommunications terminals are conventionally supplied with a SIM unlocking component which is executable by a processor of the telecommunications terminal. The SIM unlocking component is configured to remove or modify the restriction on the telecommunications terminal regarding the SIMs that will allow operation of the telecommunications terminal, only when provided with a special message, known as the SIM unlock code (typically a ten to twenty digit code). The expected SIM unlock code (i.e. the code required to unlock the terminal), or data with which a received SIM unlock code can be verified must somehow be stored by the unlocking component in order to verify the validity of received SIM unlock codes.

SIM unlock codes may be derived from a telecommunications terminal's IMEI or MCC codes using a mathematical formula. The IMEI and MCC codes are known to both the telecommunications terminal and the network operators that ship the telecommunications terminal. A SIM unlock code derived from the IMEI or MCC can be generated using the mathematical formula and then entered on the telecommunications terminal (for example, by manual keying-in or by over the air transmission). If the entered SIM unlock code matches the expected SIM unlock code pre-stored on the telecommunications terminal during its manufacture (or by the network prior to shipping) or the entered SIM unlock code can be validated in some way by the unlocking component, then the SIM unlock application performs the necessary modifications to the telecommunications terminal to remove or modify the restrictions on the type of SIMs with which the telecommunications terminal will operate fully.

More recently, SIM unlock codes have been generated completely randomly. The SIM unlock code for each telecommunications terminal is stored securely on the telecommunications terminal for access by the SIM unlock application, and is also stored securely by the network. Therefore, the network is able to provide such a SIM unlock code to the telecommunications terminal when this is appropriate.

It has been known for unauthorised third parties to provide SIM unlock codes to users of telecommunications terminals independently of the network provider. This is possible if the SIM unlock code is based on the IMEI or MCC code of a telecommunications terminal and the mathematical formula discussed above becomes known. This would also be possible if the secure network store of the random SIM unlock codes was accessed in an unauthorised manner. SIM unlock codes are provided by unauthorised third parties, for example, in an internet based service or an in-store service.

It is desirable for the network that provides the telecommunications terminal to prevent or restrict unauthorised third parties from providing SIM unlock codes to the SIM unlock application.

According to a first aspect of the invention, there is provided the method specified in claim 1.

According to a second aspect of the invention, there is provided the method specified in claim 13.

According to a third aspect of the invention, there is provided the method specified in claim 15.

In the embodiment to be described in more detail below, an unauthorised third party is unable to unlock the telecommunications terminal by providing a SIM unlock code derived from a SIM unlock component because no SIM unlock component is present on the telecommunications terminal—the SIM unlock component is only provided to the telecommunications terminal following an authorised request for download. Advantageously, the SIM unlock component is deleted by the telecommunications terminal after use. Accordingly, the SIM unlock component is only present for the time an authorised user requires to unlock the telecommunications terminal. This hinders or prevents, for example: a party unlocking the telecommunications terminal in an authorised manner for use with a previously unauthorised SIM; deduction of the SIM unlock code from the unlocked terminal, and providing the SIM unlock component in an unauthorised manner to a SIM locked handset thereby to unlock a SIM locked telecommunications terminal for use with an unauthorised SIM; or other exploitation of vulnerabilities in the SIM unlock application to unlock a SIM locked telecommunications terminal.

The SIM unlock component, when present on the mobile terminal, may form part of the application that performs locking of the mobile terminal. The SIM unlock component/application may include instructions for a data processor to perform operations to effect unlocking of the terminal.

According to a fourth aspect of the invention, there is provided the method specified in claim 18.

According to a fifth aspect of the invention, there is provided the system specified in claim 24.

According to a sixth aspect of the invention, there is provided the telecommunications terminal specified in claim 26.

In embodiments to be described, the telecommunications terminal is a mobile or cellular telecommunications terminal and the unlock application is a SIM unlocking application. The telecommunications terminals are provided with a SIM locking function in order to apply the SIM locking procedure. The SIM unlock application is sent to the telecommunications terminal in a SIM unlock message.

The SIM unlock message may also include an authentication token which proves the authenticity of the SIM unlock message. The authentication token may be in the form of a digital signature to be checked by the telecommunications terminal. In the following embodiments, checking is performed by a public/private key system. The digital signature is generated using the private key of the entity (hereinafter known as the “administrator”) that issues the SIM unlock message. The key used to check the validity of the digital signature is the public key of the administrator.

As will be readily appreciated, the authentication token may alternatively be verified using a key shared between the administrator and the terminal and which is stored securely on the terminal.

The public key used to check the validity of the digital signature may be accessed from a predetermined secure store of the telecommunications terminal. This may prevent the telecommunications terminal being modified in some way by an attacker so that the public key is retrieved from a different location, where there key held in storage is modified in an unauthorised manner.

In the embodiments detailed below, the “digital signature” of the message is generated by the administrator: firstly, by applying a hashing function to the SIM unlock application in order to generate a message digest of that application; and then the message digest is signed (in certain cases, encrypted) using the private key of the administrator. For the purposes of the following discussion, the signed message digest is referred to as a digital signature. When performing the verification, the digital signature is verified (decrypted) using the public key of the administrator, which is well known and widely distributed (it may be pre-stored in the telecommunications terminal during manufacture or may be provided in a certificate received from a certificate authority) using the message digest of the received message. A hashing algorithm corresponding to or identical to the hashing algorithm used by the administrator is executed in the telecommunications terminal in order to generate a message digest of the SIM unlock application contained in the message. If the signature verification is successful, then this indicates: (1) that the message was received from the administrator and not some unauthorised third party (because only the administrator has knowledge of its private key, and therefore the administrator is the only entity that can generate messages which can be verified by the administrator's public key), and (2) the message has not been altered during transmission from the administrator to the telecommunications terminal (because the message digest of the signed message matches the message digest of the received message).

If the administrator's public key is not pre-stored by the terminal, then the message may further include a public key certificate which indicates the public key to be used to verify the digital signature of the received message, and proves the authenticity of this administrator's public key. This certificate is issued by a certificate authority (CA) whose public key is pre-stored by the terminal. The terminal can verify the certificate (i.e. verify the CA's digital signature on the certificate contents) using the CA's public key stored by the terminal. The validity of this certificate must be verified by the terminal, and this may involve the telecommunications terminal contacting the certificate authority. For example, the telecommunications terminal can contact the certificate authority to determine whether the certificate has been revoked. Also, the certificate may indicate the term (time period) of its validity. The telecommunications terminal may check that the certificate is not outside its term—for example, by referring to a trusted time source. Only after the digital signature on the received message has been verified, and (if a certificate is provided) the public key certificate has been verified and the validity of the certificate has been confirmed, does the processor cause the SIM unlock application to install and run. Thus, only a SIM unlock application with a valid certificate is installed.

If the SIM unlocking application is not unique to the receiving terminal, then the message containing the SIM unlock application may also be encrypted to prevent the application code from being accessed (e.g. sniffed over the radio interface) and installed in an unauthorised manner on additional terminals.

Advantageously, the telecommunications terminal may include a secure execution environment, which runs concurrently with but separately from the main terminal operating system of the telecommunications terminal. The secure execution environment is a secure, managed-code, runtime environment for protecting applications installed and running therein from deviant applications running in the main operating system, bugs, vulnerabilities or malfunctioning of the main operating system, and also from third party attack. A verification application advantageously runs in the secure execution environment in which the certificate and digital signature are verified.

For a better understanding of the present invention, embodiments will now be described, by way of example only, with reference to the accompanying drawings, in which:

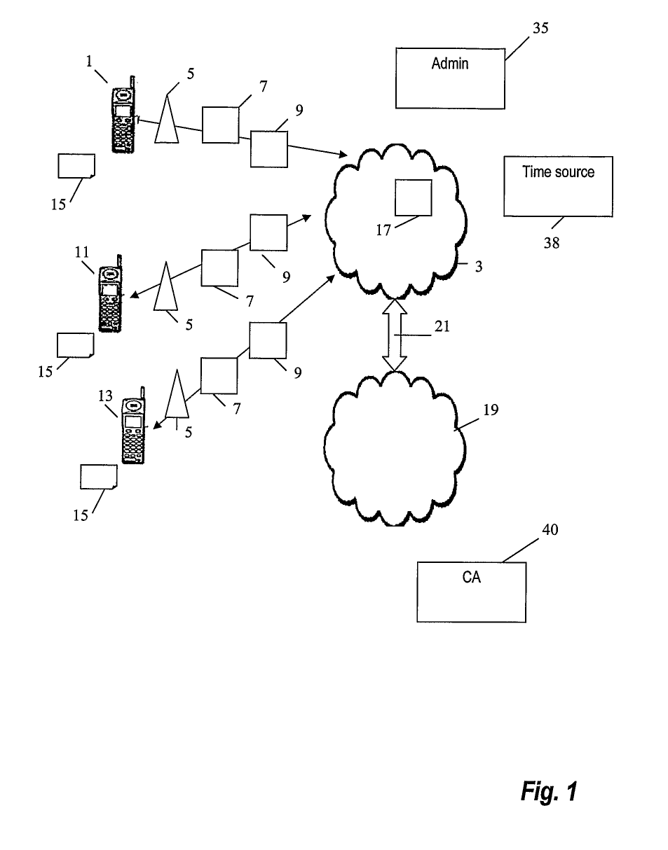

FIG. 1 shows schematically the elements of a telecommunications network including three mobile telecommunication terminals;

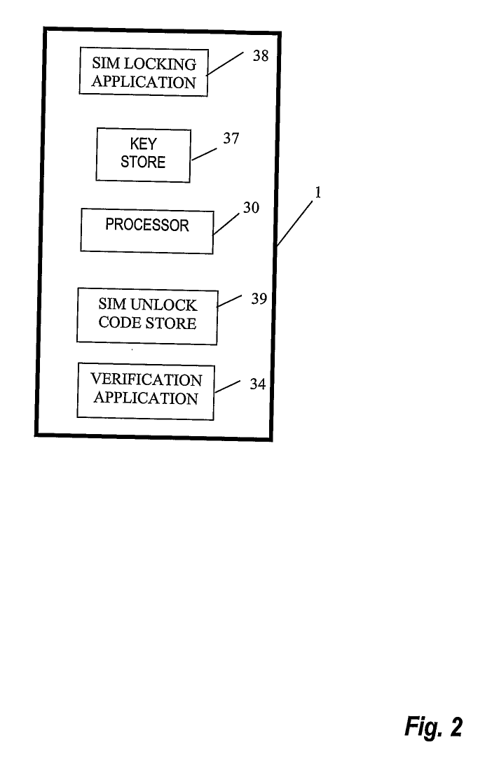

FIG. 2 shows schematically some elements present in one of the telecommunications terminals of FIG. 1;

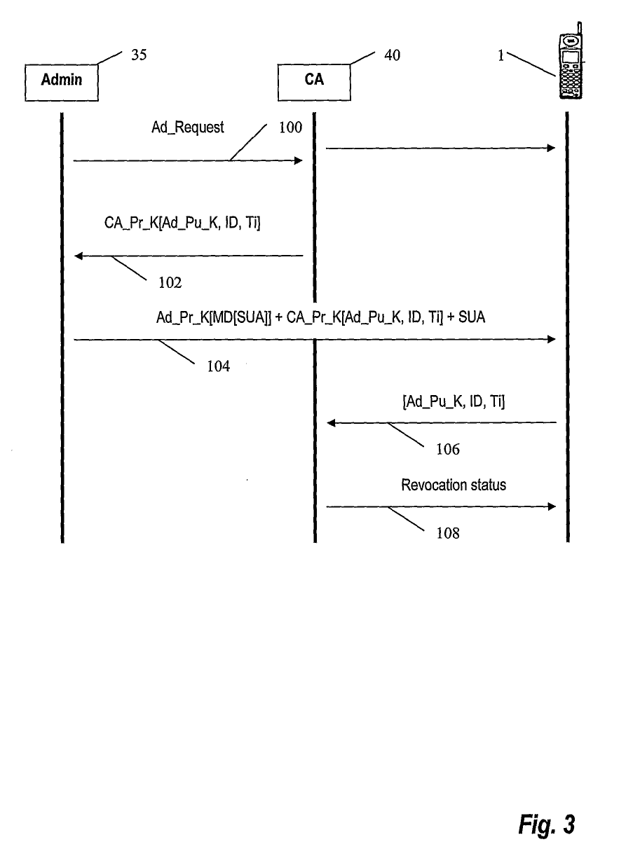

FIG. 3 shows the exchange of messages between the telecommunications terminal of FIG. 2, an administrator and a certificate authority;

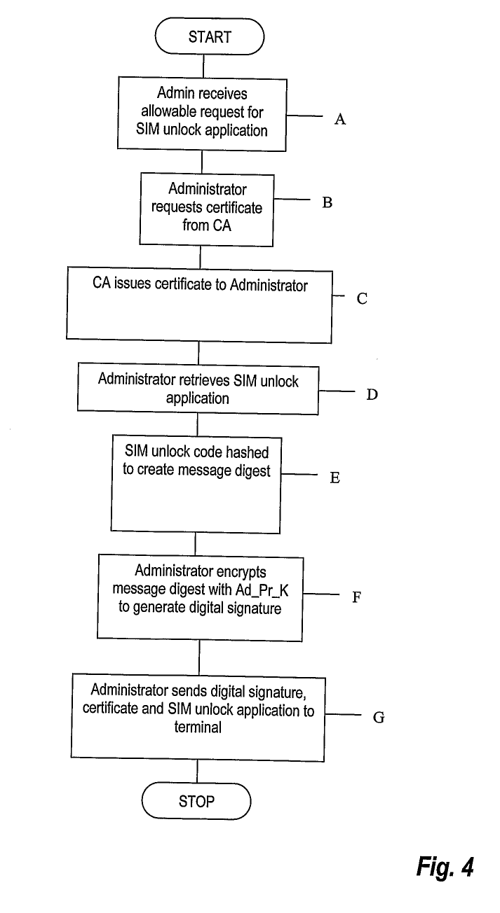

FIG. 4 is a flow chart showing the steps taken when the administrator of FIG. 3 receives a request to provide a SIM unlock application to the telecommunications terminal on FIGS. 2 and 3;

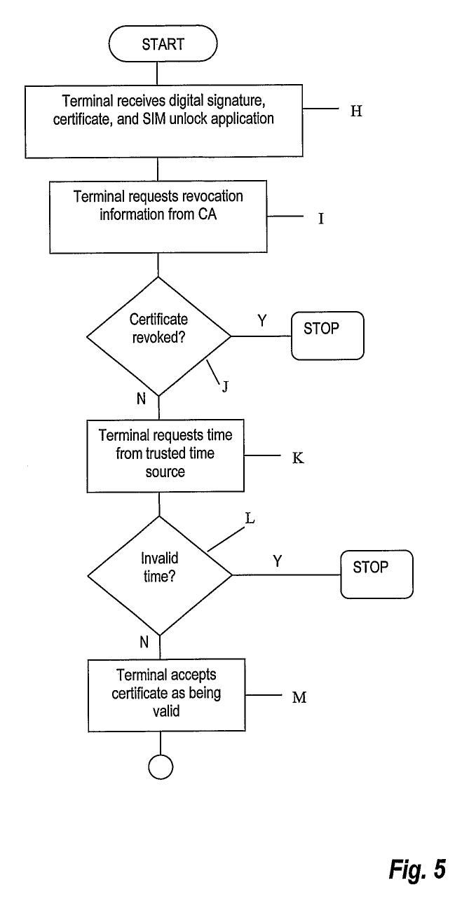

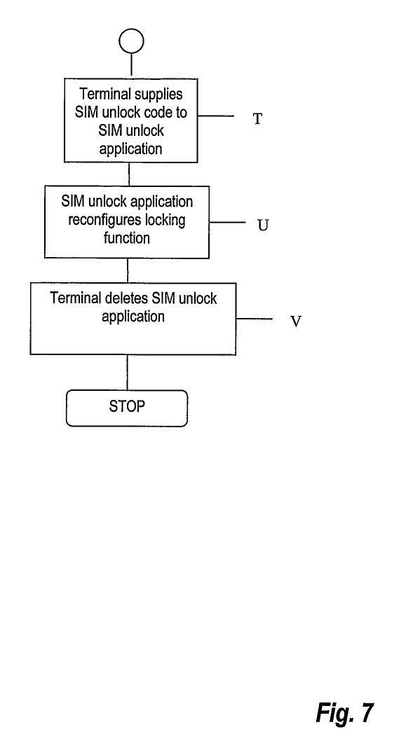

FIGS. 5, 6 and 7 are flow charts which shows the steps taken by the telecommunications terminal of FIGS. 2, 3 and 4 on receipt of a SIM unlock message;

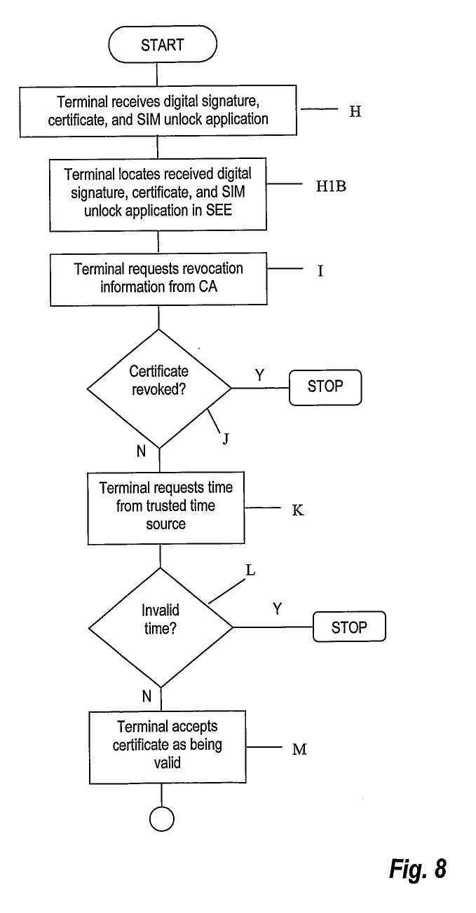

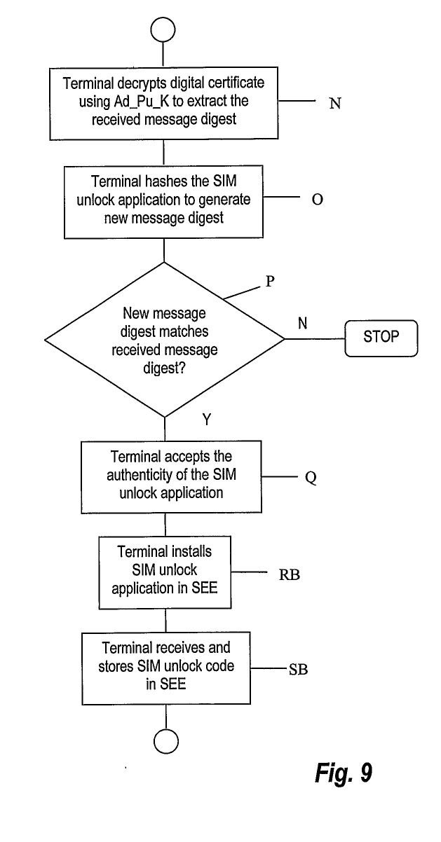

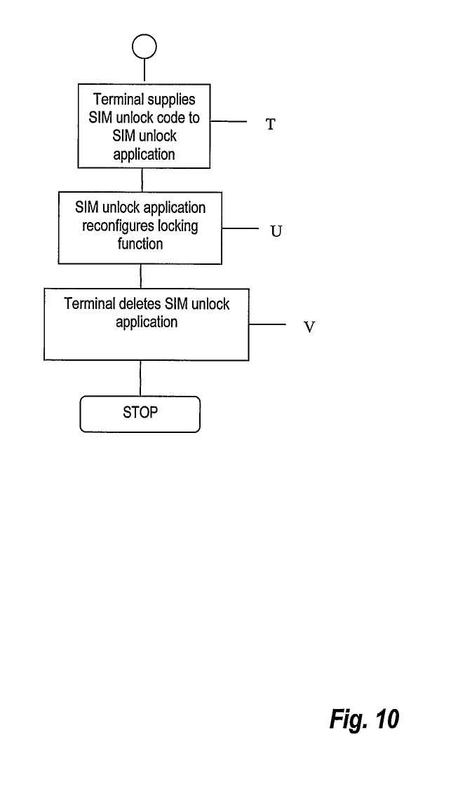

FIGS. 8, 9 and 10 correspond to FIGS. 5, 6 and 7, respectively, but modified in accordance with a second embodiment of the invention; and

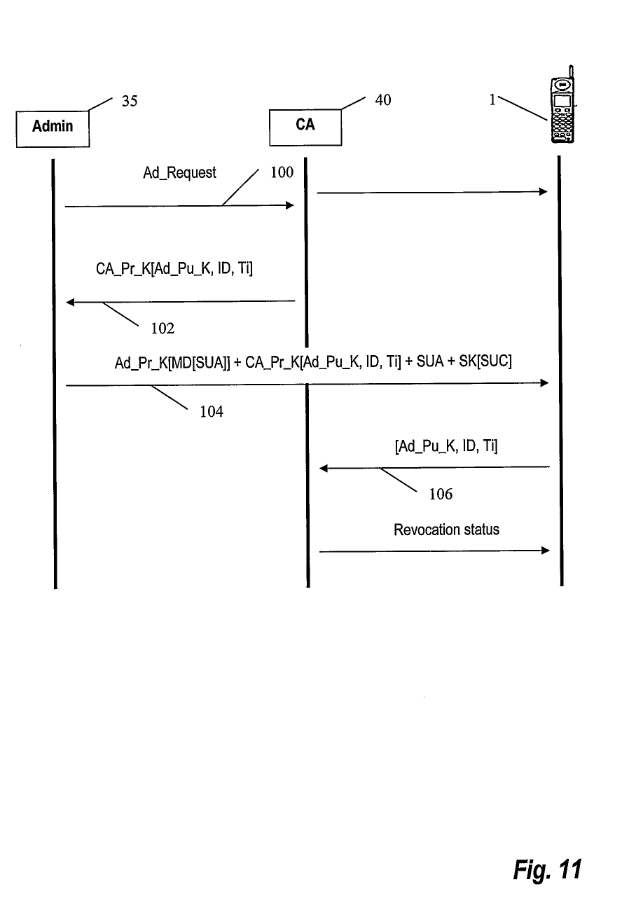

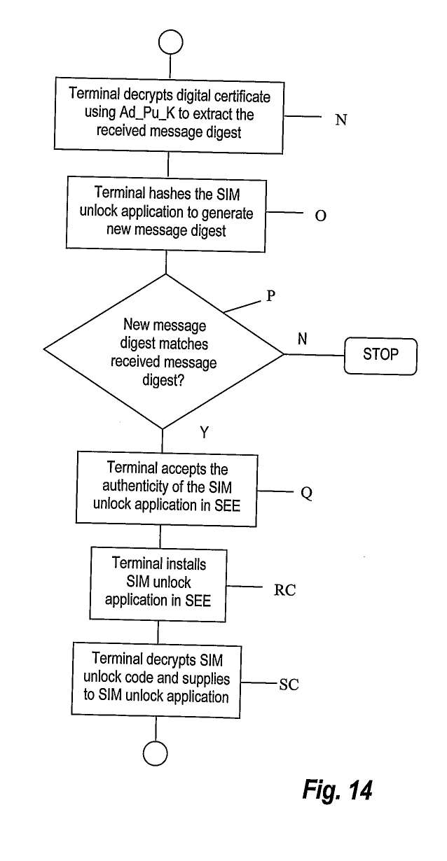

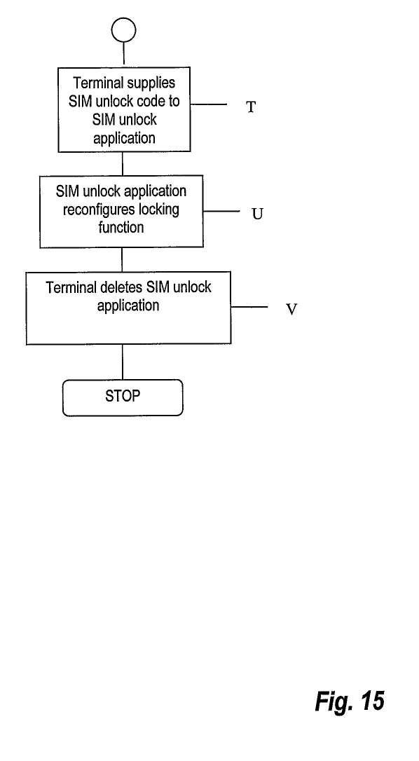

FIGS. 11 to 15 correspond to FIGS. 3, 4, 8, 9 and 10, respectively, but modified in accordance with a third embodiment of the invention.

In the drawings like elements are designated with the same reference signs.

The elements of a conventional mobile or cellular telecommunications network will first be briefly described with reference to FIG. 1.

FIG. 1 shows schematically a network in which the invention may be used. The figure shows a cellular network. However, it should be appreciated that the invention is applicable to any type of network, although it is particularly applicable to a network where at least some of the devices communicate using mobile telecommunications/wireless data transmission.

A first telecommunications terminal 1 is registered with a GSM/GPRS or UMTS (3G) mobile telecommunications network 3. The telecommunications terminal 1 may be a handheld mobile telephone, a personal digital assistant (PDA) or a laptop computer equipped with a datacard. The telecommunications terminal 1 communicates wirelessly with mobile telecommunications network 3 via the radio access network (RAN) of the mobile telecommunications network 3, comprising, in the case of a UMTS network, a base station (Node B) 5, and a radio network controller (RNC) 7. Communications between the telecommunications terminal 1 and the mobile telecommunications network 3 are routed from the radio access network via GPRS support nodes (SGSN) 9, which may be connected by a fixed (cable) link to the mobile telecommunications network 3. An administrator 35 (FIG. 1) is associated with the mobile network 3 to issue SIM unlock messages in response to requests from the network 3 as will be described below.

In a conventional manner, a multiplicity of other telecommunications terminals are registered with the mobile telecommunications network 3. These telecommunications terminals include second and third telecommunications terminals 11, 13. The second and third telecommunications terminals 11, 13 communicate with the mobile telecommunications network 3 in a similar manner to the telecommunications terminal 1: that is, via an appropriate Node B 5, RNC 7 and SGSN 9.

The mobile telecommunications network 3 includes a gateway GPRS support node (GGSN) 17 which enables IP-based communications with other networks, such as the Internet or other IP network 19 via an appropriate link 21.

Each of the telecommunications terminals 1, 11 and 13 is provided with a respective subscriber identity module (SIM) 15. During the manufacturing process of each SIM, authentication information is stored on the SIM under the control of the mobile telecommunications network 3. The mobile telecommunications network 3 itself stores details of each of the SIMs issued under its control. In operation of the mobile telecommunications network 3, each of the telecommunications terminals 1, 11, 13 is authenticated (for example, when the user activates the telecommunications terminal in the network with a view to making or receiving calls) by the network sending a challenge to the telecommunications terminal 1,11,13 incorporating a SIM 15, in response to which the SIM 15 calculates a reply (dependent on the predetermined information held on the SIM—typically an authentication algorithm and a unique key Ki) and transmits it back to the mobile telecommunications network 3. The mobile telecommunications network 3 includes an authentication processor 17 which generates the challenge and which receives the reply from the telecommunications terminal 1, 11, 13.

Using pre-stored information identifying the relevant SIM 15, the authentication processor calculates the expected value of the reply from the telecommunications terminal 1, 11, 13. If the reply received matches the expected calculated reply, the SIM 15 and the associated telecommunications terminal are considered to be authenticated.

It should be understood that such an authentication process can be performed for any telecommunications terminal provided with a SIM 15 under control of the mobile telecommunications network 3. In the embodiment each telecommunications terminal 1,11,13 communicates wirelessly with the mobile telecommunications network 3 via the network's radio access network, although this is not essential. For example, the telecommunications terminal may communicate with the network via the fixed telephone network (PSTN), via a UMA “access point” and/or via the Internet.

The SIM 15 used by each telecommunications terminal 1,11,13 may be a SIM of the type defined in the GSM or UMTS standards specifications, or may be a simulation of a SIM—that is, software or hardware that performs a function corresponding to that of the SIM. The SIM may be in accordance with the arrangement described in WO-A-2004 036513.

Each telecommunications terminal 1,11,13 (and any other telecommunications terminals having a subscription with the network 3) may be locked to the associated SIM 15, which is also provided by the network 3. For example, the first telecommunications terminal 1 may be configured so that it will only fully operate when it is functionally associated with the SIM 15 issued by the network 3, and not by any other mobile or cellular telecommunications network.

Referring now to FIG. 2, each telecommunications terminal 1,11,13 is provided with a processor 30 which runs a main operating system, such as Symbian. Each telecommunications terminal 1,11,13 is also provided with a verification application 34, a key store 37 and a SIM unlock codes 39. The function of these will be described below.

The mobile terminal includes a SIM locking application 38.

The steps performed when a user of the first telecommunications terminal 1 wishes to remove the SIM lock restriction applied by the SIM locking application 38 of the first telecommunications terminal 1 will now be described with reference to FIG. 3 and the flow charts of FIGS. 4, 5 and 6. The administrator 35 associated with the network 3 stores or obtains a SIM unlock application for each telecommunications terminal 1, 11,13 which subscribes to the network 3. The SIM unlock application, when present on the mobile terminal, will form part of the SIM locking application already present on the mobile terminal. The SIM unlock application may not therefore be a stand-alone application but may be a component of the SIM locking application. The administrator 35 also stores or obtains the SIM unlock code of each telecommunications terminal 1, 11, 13 that subscribes to the network 3. An arrangement between a trusted certificate authority (CA) 40 (see FIG. 1) and the network 3 enables the certificate authority 40 to issue certificates to certify communications from the administrator 35. The certificate authority communicates with the network 3 via the IP network 19 and link 21, although it could be connected to the network 3 by other means.

The certificate authority 40 has a public key (certificate authority public key CA_Pu_K) which is distributed without restriction to telecommunications terminals 1, 11, 13 and a private key (certificate authority private key CA_Pr_K) that is known only to the certificate authority 40. The keys are mathematically related in a conventional manner, and it is computationally infeasible to deduce one from the other.

Similarly, the administrator 35 has a public key (Ad_Pu_K) which is distributed without restriction to all of the telecommunications terminals 1,11,13 and a private key (Ad_Pr_K) that is known only to the administrator 35.

In the first step, step A of the FIG. 4 flow chart, the administrator 35 receives an allowable request for a SIM unlock application. Such a request may be received by the network 3 from the user of the first telecommunications terminal 1. The allowability of the request may depend on the contractual relationship between the user of the first telecommunications terminal 1 and the network 3. If the network 3 considers the request to be allowable, a message to issue a SIM unlock application will then be provided by the network 3 to the administrator 35.

Next, at step B, the administrator 35 requests that the certificate authority 40 provide it with a certificate to verify the administrator's identity. This is shown as message 100 in FIG. 3. The certificate authority 40 generates a certificate for the administrator 35 which includes the following information:
The administrator 35 public key (Ad_Pu_K)
information relating to the identity of the administrator (ID)
Optionally a time period (Ti) during which the certificate is valid.

The information is signed using the certificate authority's private key (CA_Pr_K) and can be represented as: CA_Pr_K[Ad_Pu_K,ID,Ti].

Next, at step C the certificate authority 40 sends the certificate (digital certificate CA_Pr_K[Ad_Pu_K,ID,Ti]) to the administrator 35 in a message 102 (see FIG. 3). As shown in FIG. 1, the administrator 35 is connected to the certificate authority 40 via the mobile telecommunications network 3, the link 21 and the IP network 19. This allows data to be exchanged between the administrator 35 and the certificate authority 40.

Next, at step D, the administrator 35 retrieves from the network 3, or obtains from a store held itself, the SIM unlock application (SUA) for the telecommunications terminal 1.

Next, at step E, the administrator 35 activates a hashing algorithm which hashes the SIM unlock application (SUA) for the telecommunications terminal 1 to create a message digest (MD[SUA])—that is, a value representative of the SIM unlock application (SUA) but from which the SIM unlock application (SUA) cannot be derived. The hash algorithm is a one-way hashing algorithm.

Next, at step F, the administrator 35 encrypts the message digest (MD [SUA]) using the administrator 35 private key (Ad_Pr_K) to generate a digital signature: Ad_Pr_K[MD[SUA]]. This digital signature can also be considered to be an authentication token. As noted previously, the encryption of a message digest constitutes one example of a digital signature (one which is valid for RSA encryption schemes such as those illustrated in the embodiments presented herein).

Next, at step G, the administrator 35 sends the digital signature, certificate and SIM unlock application (SUA) to the telecommunications terminal 1 in message 104:

Ad_Pr_K[MD[SUA]]+CA_Pr_K[Ad_Pu_K,ID,Ti]+SUA

This message 104 is sent from the administrator 35 to the network 3 then transmitted to the first telecommunications terminal 1 via SGSN 9 and the radio access network, 5,7.

Thus, the SIM unlock message 104 comprises a digital signature—(AD_Pr_K[MD[SUA]]) and a certificate (CA_Pr_K[Ad_Pu_K,ID,Ti]) issued by the certificate authority 40, in addition to the SIM unlock application.

The flow chart of FIG. 5 shows the steps taken when the first telecommunications terminal 1 receives the message 104 from the administrator 35—step H. The message 104 will only be receivable by the first telecommunications terminal 1 when the first telecommunications terminal 1 is connected to the network 3 via the radio access network 5,7. The message 104 may be transmitted by any suitable mechanism, such as an SMS message, WAP push etc. The message is transmitted over the air.

The received message 104 is processed by the processor 30 (FIG. 2) and is identified as being for processing by the verification application 34. The verification application 34 is activated by the processor 30 to process the message 104. The verification application 34 identifies that the message 104 includes a digital signature (Ad_Pr_K[MD[SUA]]), a certificate (CA_Pr_K[Ad_Pu_K,ID,Ti]) from the certificate authority 40, and a SIM unlock application.

At step I the verification application 34 decrypts the certificate (CA_Pr_K[Ad_Pu_K,ID,Ti]) using the certificate authority's 40 public key (CA_Pu_K), which may be pre-stored on the first telecommunications terminal 1. Successful decryption of the certificate proves that the certificate authority created it. The content of the certificate (Ad_Pu_K,ID,Ti) can then be extracted. The administrator public key (AD_Pu_K) is stored in key store 37. The first telecommunications terminal 1 then generates a message to request verification of the validity of the certificate by the certificate authority 40. A certificate status request is sent to the certificate authority 40 from the first telecommunications terminal 1 in message 106.

At step J the certificate authority 40 determines whether the certificate is revoked. The certificate might be revoked, for example if the private key of the administrator 35 (AD_Pr_K) is known to have been compromised (by being disclosed to unauthorised third parties, for example). The revocation status of the certificate is then transmitted from the certificate authority 40 to the first telecommunications terminal 1 over the air, via the radio access network 5,7 in a message 108.

If the message 108 indicates that the certificate is revoked, the SIM unlock application (SUA) is not processed further. Optionally, an indication may be given to the user on the display of the telecommunications terminal 1 that the SIM unlocking has been unsuccessful.

If message 108 indicates that the certificate is valid (and not revoked) then, at step K, the telecommunications terminal 1 requests the current time. The current time may be provided by an internal secure clock on the telecommunications terminal 1 or obtained from a time source 38 (FIG. 1) associated with the network 30.

At step L the current time is compared to the time period indication Ti for which the certificate provided by the certificate authority 40 is valid (if included). If the current time is outside the valid time period Ti of the certificate, the process is stopped. Optionally, the user of the telecommunications terminal may be given an indication that the process has stopped on the display of the telecommunications terminal 1.

If the current time is within the time period Ti specified in the certificate, the telecommunications terminal accepts the certificate as being valid—step M.

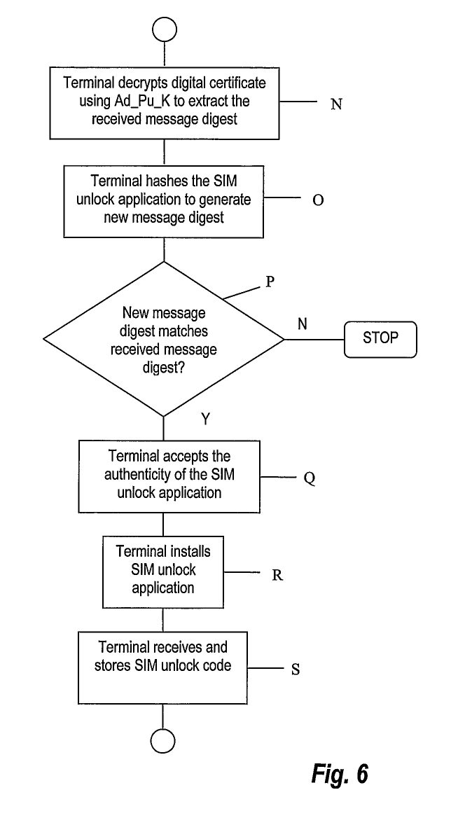

After step M, the first telecommunications terminal 1 may automatically pass to step N (FIG. 6) in order to verify the validity of the digital signature Ad_Pr_K[MD[SUA]].

At step N, the digital signature contained in the SIM unlock message 104 is decrypted using the administrator 35 public key (Ad_Pu_K) stored in store 37 and that was extracted from the certificate (CA_Pr_K[Ad_Pu_K,ID,Ti]). This allows the message digest MD of the SIM unlock application MD [SUA] and the SIM unlock application (SUA) itself to be extracted.

At step O the SIM unlock application (SUA) from the message 104 is hashed using a hashing algorithm that is the same as the hashing algorithm employed to generate the message digest by the administrator 35. The message digest generated by the telecommunications terminal and the message digest received from the administrator 35 are compared at step P.

At step P, if the message digests do not match, the process is stopped and the SIM unlock operation terminates. However, if the message digests match, the telecommunications terminal 1 accepts the authenticity of the SIM unlock application (SUA) from the message 104—step Q. The authenticity of the SIM unlock application (SUA) can be accepted at step R because the successful decryption of the digital signature (Ad_Pr_K[MD[SUA]]) using the administrator's 35 public key (Ad_Pu_K) indicates that the digital signature was generated using the administrator 35 private key (Ad_Pr_K). As only the administrator 35 should know its private key (Ad_Pr_K), this confirms that the administrator 35 did indeed send the SIM unlock message 104, rather than an unauthorised third party. The steps H to M described in relation to the flow chart of FIG. 5 independently confirm that the administrator's 35 private key (Ad_Pr_K) has not been compromised and that the administrator 35 is authorised to issue SIM unlock messages. Further, the calculation and comparison of the message digests confirm that the SIM unlock application (SUA) received has not been altered since it was generated by the administrator 35.

At step R the processor installs the SIM unlock application (SUA) in the first telecommunications terminal 1.

At step S, a valid SIM unlock code is entered into the telecommunications terminal, perhaps in response to an invitation displayed on the telecommunications terminal. The SIM unlock code may be provided to the user by email, or in a store or by other telephone means, who enters the code using the keypad of the telecommunications terminal. The SIM unlock code is stored in a SIM unlock code store 39 (FIG. 2).

At step T, the presence of the SIM unlock code in store 39 is detected by the processor 30, which prompts the processor 30 to retrieve the SIM unlock code from the store 39 and to activate the SIM unlock application while providing that application with the SIM unlock code (SUC). The SIM unlock application then operates in a conventional manner to compare the received SIM unlock code (SUC) with the SIM unlock code stored on the first telecommunications terminal 1 (for example at manufacture). If the SIM unlock codes match, the SIM unlock application will modify the SIM locking function in the telecommunications terminal 1 in such a way that the restriction on the type of SIMs 15 that are operable with the telecommunications terminal is modified or removed.

At step V the telecommunications terminal deletes the SIM unlock application from the telecommunications terminal. If the locking function is again caused to SIM lock the telecommunications terminal, it will therefore be necessary to repeat steps A to T to unlock the telecommunications terminal.

FIGS. 8 to 10 show a second embodiment of the invention, which is a modification to the first embodiment. In this modification, each telecommunications terminal 1, 11, 13 has a secure execution environment (SEE) running concurrently with the main operating system of the telecommunications terminal, also run by processor 30 (FIG. 2). A verification application is located in the secure execution environment for handling checking of the received certificate and digital signature.

Parts common to the first and second embodiment are given the same reference numerals in FIGS. 8 to 10 as in FIGS. 5 to 7 and will not be described in detail.

Referring to the flow chart of FIGS. 8 to 10, which corresponds to the flow chart of FIGS. 5 to 7 of the first embodiment, step H is performed in the same manner as in the first embodiment. An additional step H1B is included at which the telecommunications terminal transfers the downloaded image of the SIM unlock application, the certificate and the digital signature to the secure execution environment. The SIM unlock code store 39 and key store 37 are located in the secure execution environment.

Steps I to Q are performed by the verification application 34 in the secure execution environment, communicating with the external certificate authority 40 and the time source 38 where appropriate. When the authenticity of the SIM unlock application is accepted at step Q, the verification application 34 allows the processor 30 to install the SIM unlock application in the secure execution environment (new step RB)

At new step SB, which does not necessarily follow immediately after step RB, the telecommunications terminal receives a SIM unlock code and stores the code in the SIM unlock code store 39.

Steps T to V are performed in the same manner as in the first embodiment.

Locating and checking the certificate and digital signature, and installing and activating the SIM unlock application in the secure execution environment provides improved security over the first embodiment and over conventional methods of unlocking a SIM.

In a third embodiment the procedure performed at the telecommunications terminal 1, shown in the flow charts of FIGS. 11 to 15, is modified from the corresponding procedures of the first and second embodiments, shown in FIGS. 3 and 4, and the corresponding procedure of the second embodiment shown in the flow charts of FIGS. 8 to 10. Steps common to these Figures have the same reference numerals and are not described in detail.

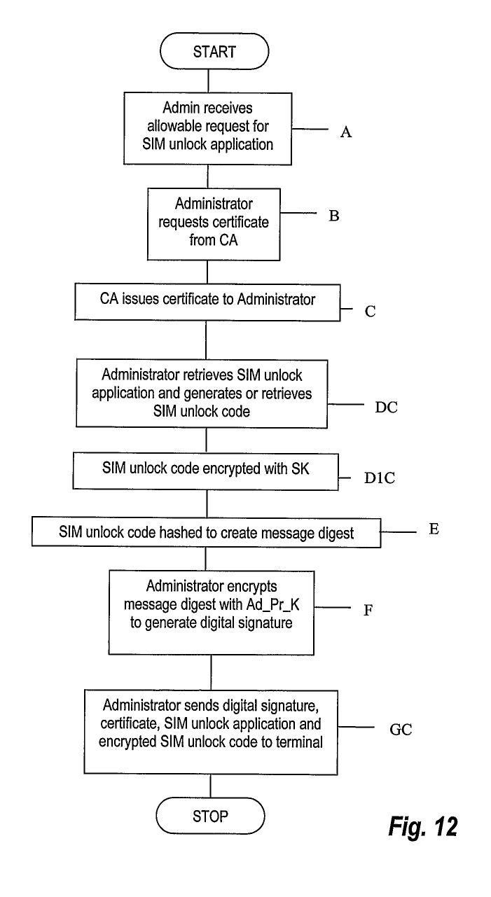

Referring to FIG. 12, steps A to C are performed in the same manner as in the second embodiment. Step D of the FIG. 4 flowchart is modified (to new step DC of the third embodiment shown in FIG. 12) so that the administrator 35 retrieves the SIM unlock application from the network 3 or from a store belonging to the administrator 35, and also generates or retrieves from a SIM unlock code store a SIM unlock code.

At the additional step D1C, the SIM unlock code is encrypted using a secret key (SK) shared between the mobile terminal 1 and the administrator (SK). Steps E and F are performed in the same manner as in the second embodiment.

The message 104 of FIG. 3 is modified (to a message 204 in the third embodiment) so that the administrator sends to the telecommunications terminal the digital signature, certificate, SIM unlock application (SUA) and encrypted SIM unlock code (SUC) in message 204:

Ad_Pr_K[MD[SUA]]+CA_Pr_K[Ad_Pu_K,ID,Ti]+SUA+SK[SUC]

Step G of the first and second embodiments is modified to step GC so that the encrypted SIM unlock code is sent by the administrator 35 to the network 3 then transmitted to the first telecommunications terminal 1 via SGSN 9 and radio access network 5, 7.

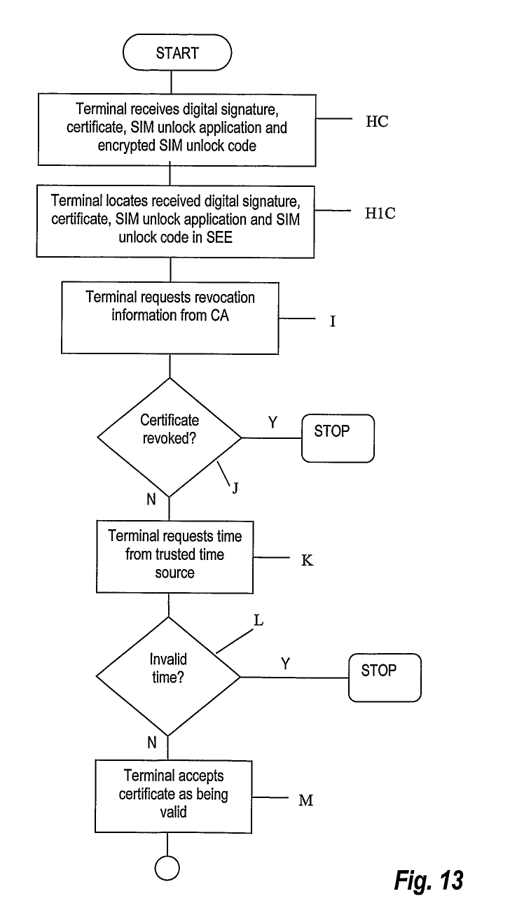

Step H of the FIG. 8 flowchart of the second embodiment is modified (to step HC in FIG. 13) so that the first telecommunications terminal 1 receives the digital signature, certificate, the SIM unlock application and the encrypted SIM unlock code (message 204B). Step H1B in FIG. 8 is modified (to step H1C in FIG. 13) so that the first telecommunications terminal 1 locates the downloaded image of the SIM unlock application, the SIM unlock code, the digital signature and the certificate in the secure execution environment. The SIM unlock code is located in a SIM unlock code store. Steps I to RC of the third embodiment are the same as the corresponding steps I to RB of the second embodiment.

Step SC differs from the corresponding step SB of the second embodiment. At step SC, the first telecommunications terminal 1 decrypts the encrypted SIM unlock code (SK[SUC]) using the shared secret key (SK). The telecommunications terminal 1 will only be able to decrypt the encrypted SIM unlock code using the shared secret key (SK) if that SIM unlock code was encrypted using the shared secret key (SK). Therefore, successful decryption of the SIM unlock code will only occur if that SIM unlock code has originated from, and been encrypted by, the administrator 35—because the shared secret key is only known to the administrator 35 (and terminal 1).

After the SIM unlock code (SUC) is extracted in step SC, steps T and V are performed in the same manner as the first embodiment, and the SIM unlocking operation can be completed.

Additionally, or alternatively, the SIM unlock application (SUA) may be encrypted by the administrator prior to transmission to the mobile terminal 1. For example, the administrator 35 and the mobile terminal 1 may have a shared secret key, which allows encryption of the SUA by the administrator 35 and decryption thereof by the mobile terminal 1.

Each of the embodiments described above prevents the SIM unlocking application from being a point of vulnerability to attack a SIM locked telecommunications terminal because the SIM unlocking application is only present following an authorized request for download and is deleted after unlock of the telecommunications terminal. Accordingly, sensitive unlock data, such as the SIM unlock application's code and logic are protected from attack as they are only present when needed. In addition, as described in the second and third embodiments, even when installed on the telecommunications terminal, the SIM unlocking application runs in a secure execution environment. If a user attempts to change the configuration of the locking function by re-flashing the telecommunications terminal back to the configuration present following manufacture, the telecommunications terminal would then be locked with no SIM unlocking application present. Advantageously, the embodiments described above comply with current United Kingdom regulatory requirements, as a SIM locked telecommunications terminal can be unlocked by a network on receipt of a legitimate unlock request. Further, should a SIM unlocking application require changing, due to it being broken, or a technical fault or intellectual property issues associated with the SIM unlocking application, the SIM unlocking application is easily and remotely replacement.

There are various possible modifications to the embodiments. In one modification possible to any one of the embodiments, a certificate is not obtained from a certificate authority. Referring to the first embodiment, this simplifies the message exchanges occurring to verify the validity of the SIM unlock message because no communications between the administrator 35 and the certificate authority 40, or between the telecommunications terminal 1 and the certificate authority 40 are required. Because no certificate is obtained from the certificate authority, the message transmitted from the administrator 35 to the telecommunications terminal 1 has the form: Ad_Pr_K[MD[SUA]]+SUA

Referring to FIG. 4 illustrating the first embodiment, step A is performed as before. Steps B and C are not performed. Steps D, E and F are performed in the same manner as the first embodiment. Step G is modified in that the administrator 35 sends the digital signature and the SIM unlock application only to the first telecommunications terminal 1 (in message 104C)—that is, no certificate is included. The procedure performed at the first telecommunications terminal 1 shown in the flow charts of FIGS. 5 to 8 is therefore modified from the corresponding procedure of the first embodiment in that the first telecommunications terminal 1 receives the digital signature and SIM unlock application, and not the certificate. Since no certificate is present, steps I, J, K, L and M are not performed. Steps N to T are then performed in the same manner as the first embodiment.

This modification is less secure than the first embodiment because there is no facility for determining whether the administrator 35 might have been compromised in some way—for example, because its private key has become known. Also, this modification is more susceptible to a “man in the middle” attack because the public key of the administrator (Ad_Pu_K) is not provided by the certificate authority in an encrypted (signed certificate), but must be obtained and stored in the store 37 by some other means.

The second and third embodiments can also be modified in a similar manner to the first embodiment if no certificate is obtained from a certificate authority.

Further, any of the embodiments can be modified so that no hashing algorithms are used. No message digests will therefore be generated. Although such a modification simplifies the processing, such an arrangement is less secure because it cannot be determined whether the SIM unlock application transmitted by the administrator 35 is the same manner as the SIM unlock application received by the first telecommunications terminal 1.

In another modification of the first embodiment, the certificate is provided to the first telecommunications terminal 1 with a timestamped proof provided by the certificate authority 40. The timestamped proof is verification that, provided the timestamped proof is not expired and is authenticated as originating from the certificate authority 40, the certificate is valid. The timestamped proof (TP) is typically valid for 1 to 2 days. Such verification obviates a need for the first telecommunications terminal 1 to check with the certificate authority whether the certificate is revoked and with the time source 38 whether the certificate is not expired. Accordingly, the certificate authority 40 need not provide an interface for such communication. Also, as there is no need for the telecommunications terminal 1 to connect to such an interface, signal traffic is reduced and potential delays are prevented.

In this modification, referring to FIG. 1 illustrating the first embodiment, step A is performed as before. Step B is modified in that the administrator 35 requests that the certificate authority (CA) 40 provide a certificate together with a timestamped proof. The certificate authority 40 generates the certificate and the timestamped proof and encrypts them using the certificate authority's private key. The information encrypted by the certificate authority 40 can be represented as: CA_Pr_K[AD_Pu_,ID,TP]. An indication of the period (Ti) of validity of the certificate is optional, and is not represented. Step C is modified in that the certificate authority 40 sends the encrypted certificate and the time stamp proof to the administrator 35. Steps E and F are performed in the same manner. Step G is modified in that the administrator 35 sends the digital signature, certificate, SIM unlock application (SUA) and time stamp proof (TP) to the telecommunications terminal 1 in modified message: Ad_Pr_K[MD[SUA]]+CA_Pr_K[Ad_Pu_K,ID,TP]+SUA. Thus, the SIM unlock message comprises a digital signature Ad_Pr_K[MD[SUA]], an encrypted certificate and timestamped proof CA_Pr_K[Ad_Pu_K,ID,TP], and the SIM unlock application (SUA). Step H is modified so that the first telecommunications terminal 1 receives the modified message, and the modified message is processed by the processor 30, which activates the verification application 34. The verification application 34 identifies that the modified message includes a digital signature (Ad_Pr_K[MD[SUA]]), a certificate and timestamped proof (CA_Pr_K[Ad_Pu_K,ID,TP]) from the certificate authority 40, and a SIM unlock application (SUA). Step I is modified in that the verification application 34 decrypts the certificate and the timestamped proof. Successful decryption of the certificate and the timestamped proof authenticates the timestamped proof and the certificate as having originated with the certificate authority 40. Step J is omitted. Signalling steps 106, 108 (FIG. 3) are not performed. Step K is modified in that the first telecommunications terminal 1 checks that the timestamped proof (TP) is not expired by checking the time against an internal clock on the first telecommunications terminal 1. Step L is omitted. Step M is modified so that if the time indicates that the timestamped proof (TP) has not expired, the timestamped proof (TP) is accepted as verification that the certificate is valid. Accordingly, in this case, the certificate is accepted as being valid. Steps N to S are performed in a similar manner.

In a yet further modification, the SIM unlock code is sent by the administrator contained within the SIM unlock application. The SIM unlock code is preferably encrypted within the SIM unlock application but is not necessarily encrypted. Nor is the SIM unlock code necessarily encrypted if separate to, but sent in, the same message as the SIM unlock application (as in the third embodiment), or sent to the first telecommunications terminal in a separate message to the unlock message.

It is possible for the SIM unlock application not to require a SIM unlock code in order to unlock a telecommunications terminal—the SIM unlock application could proceed automatically on installation to unlock the telecommunications terminal, or on activation by the processor 30. The invention allows for a type of SIM unlocking application not based on a security code to be provided to the mobile terminal. For example, if a SIM unlock application is transmitted to the telecommunications terminal in accordance with the first or second embodiment, the SIM unlock application may be replaced with a signed SIM unlock instruction. As the SIM unlock instruction is signed, it need not be a confidential code. This removes a need to manage SIM unlock codes.

In the embodiments described above, a digital signature is equated with “the encryption of a message digest with a private key”. However, as previously mentioned this is not always the case. In fact, it is only true for RSA encryption schemes. Therefore, it should be understood that the SIM unlock applications (SUAs) are signed using the administrator's private key to produce a signature (not necessarily an encrypted message digest), and then the terminal verifies the signature of the SUA using the administrator's public key (the verification algorithm takes as input the message (SUA, the signature and the public key and produces a success/failure response indicating whether the signature is valid for that public key and message or not).

1. A method of controlling a telecommunications terminal requiring an authorised input to perform at least one operation, and including a locking function that locks said at least one operation of the telecommunications terminal, the method comprising selectively transmitting to the telecommunications terminal an unlocking application, receiving the unlocking application at the telecommunications terminal and running the unlocking application to enable said at least one locked operation.

2. A method according to claim 1, wherein said at least one locked operation includes full use of the terminal with a selected subscriber identity module for authenticating the telecommunications terminal with a mobile or cellular telecommunications network.

3. A method according to claim 1, wherein said telecommunications terminal includes a first environment for running a main operating system, and a second environment that is more secure than the first environment and is adapted to store and run the unlocking application, said telecommunications terminal, on receipt of the unlocking application, locating said unlocking application in said second environment.

4. A method according to claim 1, wherein said unlocking application is received by the telecommunications terminal in a message, the message including an authentication token, the method including a step of checking the validity of the authentication token before running the unlocking application.

5. A method according to claim 4, wherein the authentication token comprises a digital signature.

6. A method according to claim 5, wherein said message includes a digital certificate containing the key to be used to verify the digital signature, the telecommunications terminal verifying the certificate and checking the validity of the certificate before running the unlocking application.

7. A method according to claim 1, wherein the unlocking application is transmitted in encrypted form and is decrypted by the terminal after receipt.

8. A method according to claim 1, wherein running the unlocking application to enable said at least one locked operation includes the unlocking application processing a valid unlock code.

9. A method according to claim 8, wherein said telecommunications terminal includes a user interface, the telecommunications terminal receiving said unlock code via said user interface.

10. A method according to claim 8, wherein said unlock code is received by the telecommunications terminal together with the unlocking application.

11. A method according to claim 8, wherein said unlock code is encrypted, said telecommunications terminal decrypting said unlock code for processing by the unlocking application.

12. A method according to claim 1, including an end step of the telecommunications terminal deleting or disabling the unlocking application from the telecommunications terminal for example once the unlocking application has enabled said at least one locked operation.

13. A system for controlling a telecommunications terminal, the telecommunications terminal requiring an authorised input to perform at least one operation, and including: a locking function for locking said at least one operation of the telecommunications terminal; a telecommunications network operable to selectively transmit to the telecommunications terminal an unlocking application; and the telecommunications terminal being adapted to receive the unlocking application and run the unlocking application to enable said at least one locked operation.

14. A system according to claim 13 adapted to perform the method of selectively transmitting to the telecommunications terminal an unlocking application, receiving the unlocking application at the telecommunications terminal and running the unlocking application to enable said at least one locked operation.

15. A telecommunications terminal requiring an authorised input to perform at least one operation, and including a locking function that locks said at least one operation of the telecommunications terminal, the telecommunications terminal being adapted to receive an unlocking application transmitted thereto and to run the unlocking application to enable said at least one locked operation.

16. A telecommunications terminal according to claim 15 adapted to perform the method of selectively transmitting to the telecommunications terminal an unlocking application, receiving the unlocking application at the telecommunications terminal and running the unlocking application to enable said at least one locked operation.

17. A method of securely receiving and storing a received message in a telecommunications terminal, the telecommunications terminal having a first environment for running an operating system, and a second environment that is more secure than the first environment; including a message being received at said telecommunications terminal and said telecommunications terminal locating a least part of said message in said second environment.

18. A method according to claim 17, wherein said message includes an application for running in said second environment.

19. A method according to claim 18, wherein said message further includes an authentication token, the method including a step of checking the validity of the authentication token before running said application.

20. A method according to claim 18, wherein the authentication token comprises a digital signature.

21. A method according to claim 20, wherein said message includes a digital certificate, the telecommunications terminal checking the validity of the certificate before running said application.

22. A method according to claim 17, wherein the message is transmitted in encrypted form and is decrypted by the terminal after receipt.

23. A method according to claim 18, including an end step of the telecommunications terminal deleting or disabling the application, for example, once the unlocking application has enabled said at least one locked operation.

24. A system for a telecommunications terminal to securely receive and store a received message, comprising a telecommunications terminal having a first environment for running an operating system, and a second environment that is more secure than the first environment, and a server for sending a message; wherein the telecommunications terminal is adapted to receive the message and to locate a least part of the message in said second environment.

25. A system according to claim 24 adapted to perform the method of securely receiving and storing a received message in a telecommunications terminal.

26. A telecommunications terminal having a first environment for running an operating system, and a second environment that is more secure than the first environment, wherein the telecommunications terminal is adapted to receive a message and to locate a least part of said message in said second environment.

27. A telecommunications terminal according to claim 26 adapted to perform the method of securely receiving and storing a received message in a telecommunications terminal.
